(19) United States
(12) Patent Application Publication
(10) Pub. No.: US 2025/0304042 A1
(43) Pub. Date: Oct. 2, 2025

(54) MOVING BODY CONTROL SYSTEM, CONTROL METHOD THEREOF, AND STORAGE MEDIUM

(71) Applicant: HONDA MOTOR CO., LTD., Tokyo (JP)

(72) Inventors: Shumon KOGA, Wako-shi (JP); Shrita SINGH, Wako-shi (JP); Rintaro IMAMURA, Wako-shi (JP)

(21) Appl. No.: 19/055,143

(22) Filed: Feb. 17, 2025

(30) Foreign Application Priority Data
Mar. 28, 2024 (JP) 2024-054474

(51) Int. Cl. B60W 30/09; B60W 10/20; B60W 30/095; B60W 30/14; B60W 50/00; B60W 50/14

(52) U.S. Cl. CPC B60W 30/09; B60W 10/20; B60W 30/0956; B60W 30/143; B60W 50/0097; B60W 50/14; B60W 2050/143; B60W 2050/146; B60W 2420/408; B60W 2554/20; B60W 2554/4041; B60W 2554/4042; B60W 2554/4045

(57) ABSTRACT

A moving body control system comprising recognizes a state of a target in an external world of a moving body; and generates a predicted traveling track of another moving body traveling in a specific lane different from a lane in which the moving body travels. The moving body control system generates the predicted traveling track for the other moving body to avoid the target in a case where it is determined that a predetermined condition corresponding to that a target existing in the specific lane is stationary is satisfied on a basis of a recognized state of a target.

### CROSS-REFERENCE TO RELATED APPLICATION(S)

This application claims priority to and the benefit of Japanese Patent Application No. 2024-054474, filed Mar. 28, 2024, the entire disclosure of which is incorporated herein by reference.

### BACKGROUND OF THE INVENTION

### Field of the Invention

The present invention relates to a moving body control system, a control method thereof, and a storage medium.

### Description of the Related Art

Conventionally, there has been known a technique of generating a traveling track of a self-vehicle for avoiding an obstacle in a case where the obstacle is found on a traveling path while a vehicle that is a moving body is traveling by automated driving (Joseph Funke et al. one person, “Simple Clothoid Lane Change Trajectories for Automated Vehicles Incorporating Friction Constraints” Journal of Dynamic Systems, Measurement, and Control, February 2016).

In a case where another moving body (for example, a vehicle) travels in another lane (for example, an opposite lane) different from the lane in which a moving body itself (for example, a self-vehicle) travels, the other moving body may approach the lane in which the moving body itself travels for some reason. Therefore, it is necessary to generate its own traveling track in consideration of the traveling track of the other moving body in order to avoid collision with the other moving body.

In such a case, when the certainty of the predicted traveling track of the other moving body is low, there is a problem that the traveling track of the moving body itself becomes unstable, such as when controlling steering of the moving body itself in accordance with the behavior of the other moving body that does not actually occur. In addition, for the prediction of the traveling track of the other moving body, only cases where the other moving body travels only in the same lane or a case where the other moving body that is out of the lane travels so as to return to the lane have been considered.

### SUMMARY OF THE INVENTION

The present invention has been made in view of the above problems, and an object of the present invention is to realize a technique capable of generating a highly reliable traveling track for another moving body traveling in another lane.

In order to solve the aforementioned issues, one aspect of the present disclosure provides a moving body control system comprising: one or more processors; and a memory storing instructions which, when the instructions are executed by the one or more processors, cause the moving body control system to function as: a target recognition unit configured to recognize a state of a target in an external world of a moving body; and a generation unit configured to generate a predicted traveling track of another moving body traveling in a specific lane different from a lane in which the moving body travels, wherein the generation unit generates the predicted traveling track for the other moving body to avoid the target in a case where it is determined that a predetermined condition corresponding to that a target existing in the specific lane is stationary is satisfied on a basis of a recognized state of a target.

Another aspect of the present disclosure provides a control method of a moving body control system, comprising: recognizing a state of a target in an external world of a moving body; and generating a predicted traveling track of another moving body traveling in a specific lane different from a lane in which the moving body travels, wherein generating the predicted traveling track for the other moving body includes generating the predicted traveling track for the other moving body to avoid the target in a case where it is determined that a predetermined condition corresponding to that a target existing in the specific lane is stationary is satisfied on a basis of a recognized state of a target.

Yet another aspect of the present disclosure provides a non-transitory computer-readable storage medium storing a program for causing a computer to function as each unit of a moving body control system, wherein the moving body control system comprising: a target recognition unit configured to recognize a state of a target in an external world of a moving body; and a generation unit configured to generate a predicted traveling track of another moving body traveling in a specific lane different from a lane in which the moving body travels, and in a case where it is determined that a predetermined condition corresponding to that a target existing in the specific lane is stationary is satisfied on a basis of a recognized state of a target, the generation unit generates the predicted traveling track for the other moving body to avoid the target.

According to the present invention, it is possible to generate a highly reliable traveling track for another moving body traveling in another lane.

### BRIEF DESCRIPTION OF THE DRAWINGS

FIG. 1 is a diagram illustrating a configuration example of a vehicle as an example of a moving body according to an embodiment;

FIG. 2 is a block diagram illustrating a functional configuration example of a control device according to the embodiment;

FIG. 3 is a diagram for explaining a predicted traveling track for another moving body according to the embodiment;

FIG. 4 is a flowchart illustrating a series of operations of driving assistance processing according to the embodiment;

FIG. 5 is a flowchart illustrating a series of operations of determination processing on a target according to the embodiment; and

FIGS. 6A to 6C are diagrams for explaining an example of generating a predicted traveling track for another moving body according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Vehicle Configuration Example>

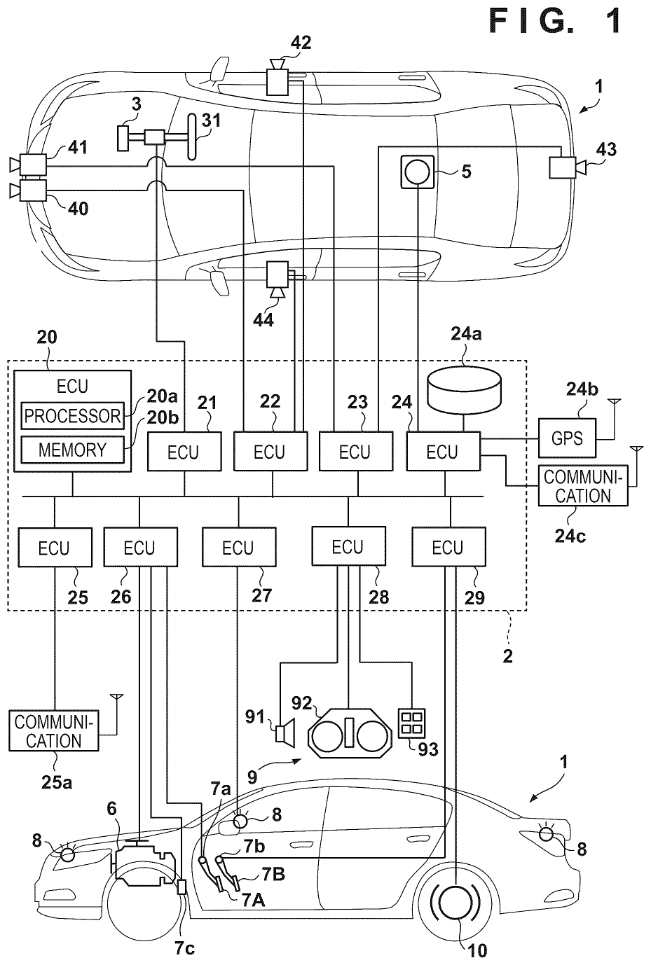

FIG. 1 is a block diagram of a vehicle 1 as an example of a moving body according to the present invention. In FIG. 1, an outline of the vehicle 1 is illustrated in a plan view and in a side view. The vehicle 1 is a four-wheeled passenger vehicle as an example, but may be a two-wheeled vehicle or another type of vehicle. In addition, a moving body control system according to the present embodiment may be a moving body, a control device such as an ECU included in a moving body, or an information processing server on a cloud for controlling a moving body. That is, a part or all of driving assistance processing to be described later according to the present embodiment may be executed in the moving body or may be executed in the information processing server on the cloud. In addition, the moving body is not limited to a vehicle, and may include various moving bodies such as a robot capable of autonomous traveling.

The vehicle 1 includes a vehicle control device (hereinafter, simply referred to as a control device 2) that controls the vehicle 1. The control device 2 includes a plurality of electronic control units (ECUs) 20 to 29 connected to be able to communicate with each other through an in-vehicle network. Each ECU includes a processor such as a central processing unit (CPU) or a graphics processing unit (GPU), a memory such as a semiconductor memory, an interface with an external device, and the like. The memory stores programs executed by the processor, data used for processing by the processor, and the like. Each ECU may include a plurality of processors, memories, interfaces, and the like. For example, an ECU 20 includes a processor 20a and a memory 20b. Processing by the ECU 20 is performed by the processor 20a executing instructions included in a program stored in the memory 20b. Instead of this, the ECU 20 may include a dedicated integrated circuit such as an application specific integrated circuit (ASIC) for performing a processing by the ECU 20. A similar configuration applies to the other ECUs.

Hereinafter, functions and the like assigned to each of the ECUs 20 to 29 will be described. Note that, the number of ECUs and functions to be performed can be designed as appropriate, and can be subdivided or integrated as compared with the present embodiment. For example, one ECU (for example, ECU 22) may have the function of another ECU.

The ECU 20 executes control related to manual traveling and automatic traveling of the vehicle 1. In the automatic traveling, at least one of steering and acceleration/deceleration of the vehicle 1 is automatically controlled. Note that, the automatic traveling by the ECU 20 may include automatic traveling (which may also be referred to as automated driving) that does not require a traveling operation by the driver and automatic traveling (which may also be referred to as driving assistance) for assisting the traveling operation by the driver. The control of traveling by the ECU 20 may include, for example, control of automatically stopping or steering a vehicle in order to avoid a collision instead of driving by the driver.

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. When the driving state of the vehicle 1 is automated driving, the ECU 21 automatically controls the electric power steering device 3 in response to an instruction from the ECU 20 and controls the traveling direction of the vehicle 1.

The ECUs 22 and 23 control detection units for detecting the surrounding situation of the vehicle and perform information processing on detection results. The vehicle 1 includes, for example, one standard camera 40 and four fisheye cameras 41 to 44 as a detection unit that detects the surrounding situation of the vehicle. The standard camera 40 and the fisheye cameras 42 and 44 are connected to the ECU 22. The fisheye cameras 41 and 43 are connected to the ECU 23. The ECUs 22 and 23 can recognize the state of the target such as the type, position, and speed of the target, the lane region on the movement route, the traveling road boundary (white line), and the dividing line (broken line or the like) between the lane and the lane by analyzing the images captured by the standard camera 40 and the fisheye camera 41 to 44. Note that, the type, number, and mounting position of the camera included in the vehicle 1 are not limited to the example of the present embodiment, and the camera may have other configurations. In addition, the vehicle 1 may include a light detection and ranging (LiDAR) or a millimeter wave radar as a detection unit for detecting a target around the vehicle 1 and measuring a distance to the target.

The standard camera 40 is attached at the center in a front part of the vehicle 1, and captures an image of a surrounding situation ahead of the vehicle 1. The fisheye camera 41 is attached at the center in the front part of the vehicle 1, and captures an image of a surrounding situation ahead of the vehicle 1. In FIG. 1, the standard camera 40 and the fisheye camera 41 are illustrated as being aligned horizontally. However, the arrangement of the standard camera 40 and the fisheye camera 41 is not so limited, and they may be aligned vertically, for example. In addition, at least one of the standard camera 40 and the fisheye camera 41 may be attached to a front portion of the roof (for example, on the vehicle interior side of the windshield) of the vehicle 1. The fisheye camera 42 is attached at the center in a right lateral side part of the vehicle 1, and captures an image of a surrounding situation on a right side of the vehicle 1. The fisheye camera 43 is attached at the center in a rear part of the vehicle 1, and captures an image of a surrounding situation behind the vehicle 1. The fisheye camera 44 is attached at the center in a left lateral side part of the vehicle 1, and captures an image of a surrounding situation on a left side of the vehicle 1.

The ECU 22 controls the standard camera 40 and the fisheye cameras 42 and 44 and performs information processing on detection results. The ECU 23 controls the fisheye cameras 41 and 43 and performs information processing on detection results. The detection units that respectively detect the surrounding situations of the vehicle are divided into two systems, and therefore the reliability of the detection results can be improved. In addition, the ECU 22 can detect the direction of the head and the line of sight of the driver using an image obtained by photographing the driver with a fisheye camera (not illustrated) installed in the vehicle interior.

The ECU 24 controls a gyro sensor 5, a GPS sensor 24b, and a communication device 24c, and performs information processing on detection results or a communication result. The gyro sensor 5 detects a rotational movement of the vehicle 1. It becomes possible to determine the course of the vehicle 1, based on a detection result of the gyro sensor 5, a wheel speed, and the like. The GPS sensor 24b detects a current location of the vehicle 1. The communication device 24c performs wireless communication with a server that provides map information and traffic information, and acquires pieces of these information. The ECU 24 is capable of accessing a map information database 24a, which is constructed in a memory, and the ECU 24 performs route search and the like from the current location to a destination. The ECU 24, the map database 24a, and the GPS sensor 24b constitute a so-called navigation device.

The ECU 25 includes a communication device 25a for inter-vehicle communication. The communication device 25a performs, for example, wireless communication with other surrounding vehicles to exchange information between the vehicles.

The ECU 26 controls a power plant 6. The power plant 6 is a mechanism that outputs driving force for rotating driving wheels of the vehicle 1, and includes, for example, an engine and a transmission. For example, the ECU 26 controls the output of the engine in response to a driver's driving operation (an accelerator operation or an acceleration operation) that has been detected by an operation detection sensor 7a, which is provided on an accelerator pedal 7A, or switches a gear ratio of the transmission, based on information such as a vehicle speed that has been detected by a vehicle speed sensor 7c.

The ECU 27 controls a light device (headlight, taillight, and the like) including a direction indicator 8 (blinker). In the example of FIG. 1, the direction indicators 8 are provided at the front portion, the door mirror, and the rear portion of the vehicle 1.

The ECU 28 controls an input and output device 9. The input and output device 9 outputs information to a passenger (for example, a driver) and receives an input of information from the driver. A voice output device 91 notifies the driver of information by, for example, a voice including a predetermined sound or utterance. The notification content is output, for example, when the ECU 22 performs driving assistance processing to be described later, determines execution of notification, and transmits the notification content to the ECU 28. The driving assistance processing will be described later. A display device 92 notifies the driver of information by displaying an image. The display device 92 is arranged, for example, in front of a driver's seat, and constitutes an instrument panel or the like. Note that, although the voice and the display have been given as examples here, information may also be notified by vibration or light. In addition, information may be notified by a combination of two or more of the voice, the display, the vibration, and the light. An input device 93 is a group of switches that are arranged at positions for the driver to be able to operate and give an instruction to the vehicle 1, but may also include a voice input device.

The ECU 29 controls a brake device 10 and a parking brake (not illustrated in the drawings). The brake device 10 is, for example, a disc brake device, and is provided on each wheel of the vehicle 1 to apply resistance against rotations of the wheels to decelerate or stop the vehicle 1. The ECU 29 controls the activation of the brake device 10 in response to a driver's driving operation (a braking operation) that has been detected by an operation detection sensor 7b, which is provided on a brake pedal 7B, for example. In a case where the driving situation of the vehicle 1 is the automated driving, the ECU 29 automatically controls the brake device 10 in response to an instruction from the ECU 20 to control the vehicle 1 to be decelerated and stopped. The brake device 10 and the parking brake can also be activated to keep the vehicle 1 in the stopped state. In a case where the transmission of the power plant 6 includes a parking lock mechanism, the parking lock mechanism can also be operated to keep the vehicle 1 in the stopped state.

### <Functional Configuration Example Implemented in ECU 22>

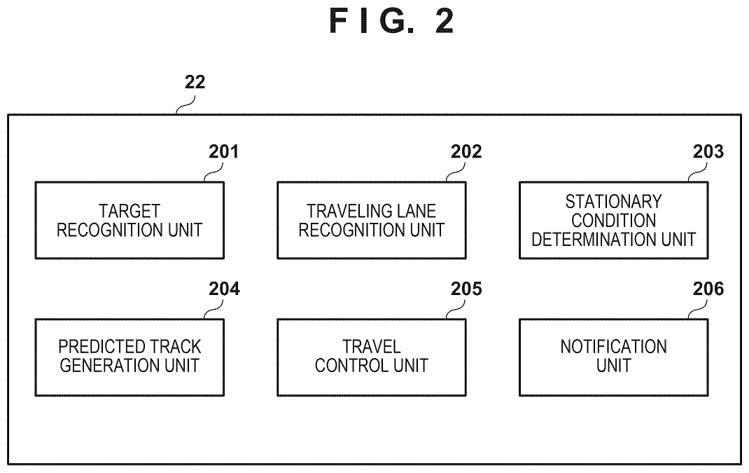

Next, a functional configuration example implemented in the ECU 22 will be described with reference to FIG. 2. Note that, some or all of the functions described below as functions implemented in the ECU 22 may be implemented in another ECU (for example, the ECU 20). The functional configuration example illustrated in FIG. 2 illustrates an example of a functional configuration implemented by the ECU 22 executing a program stored in an internal memory. In addition, the functional configuration example illustrated in FIG. 2 focuses on a configuration related to driving assistance processing to be described later. Therefore, the functions implemented in the ECU 22 are not limited to those illustrated in FIG. 2 and may include other functions. In the following description, a case where a vehicle 305 and a target 306, which will be described later, exist in opposite lanes will be described as an example. However, the present embodiment is applicable not only to the opposite lane but also to a case where the vehicle 305 and the target 306 exist in another lane (also referred to as a specific lane) different from the lane in which the vehicle 1 travels.

A target recognition unit 201 recognizes the state of the target in the external world of the vehicle 1 on the basis of at least one of the image obtained from the detection unit and the sensor information such as the LiDAR. The target includes, for example, a moving body (a peripheral vehicle, a bicycle) around the vehicle 1, a passerby such as a pedestrian or a person riding a bicycle, or a falling object. The peripheral vehicles include other vehicles on the lane in which the vehicle 1 travels and other vehicles traveling in the opposite lane of the lane in which the vehicle 1 travels. The state of the target includes, for example, the type of the target, the position of the target, the speed of the target, the movement track of the target, and the like. The position of the target may be a relative position from the vehicle 1. The target recognition unit 201 can recognize the state of the target in the external world using, for example, one or more neural networks, but may use another learning model.

A traveling lane recognition unit 202 recognizes the driving lane on the movement route on which the vehicle 1 travels on the basis of at least one of the image obtained from the detection unit and the sensor information such as the LiDAR. The information of the recognized traveling lane includes, for example, information of a traveling road boundary, a dividing line, and a lane region on the movement route. The information of the traveling road boundary and the dividing line may be given by, for example, position information of a discrete point group at every predetermined distance (for example, every one meter). The traveling lane recognition unit 202 can recognize the driving lane on the movement route by, for example, one or more neural networks, but may use another learning model. Note that, the function of the target recognition unit 201 and the function of the traveling lane recognition unit 202 may be realized by one neural network or learning model.

A stationary condition determination unit 203 uses the recognition result of the target by the target recognition unit 201 and the recognition result by the traveling lane recognition unit 202 to determine whether or not a predetermined condition corresponding to that a target existing in the opposite lane is stationary is satisfied. Processing by the stationary condition determination unit 203 will be described later.

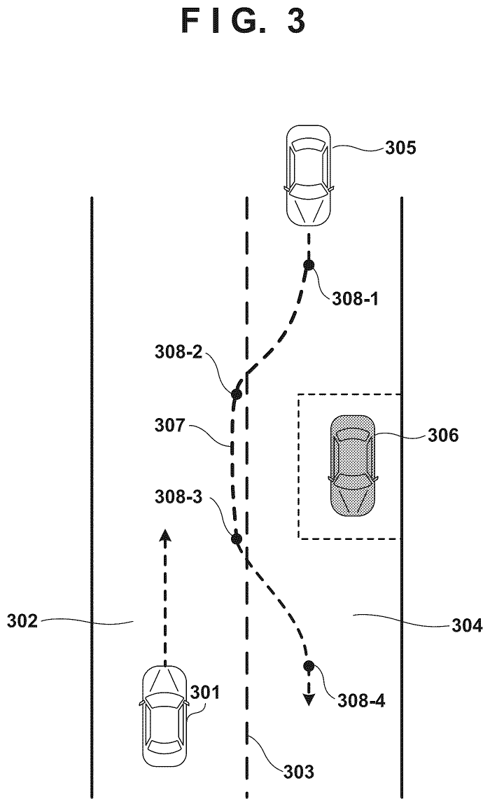

A predicted track generation unit 204 generates a predicted traveling track (also simply referred to as a predicted traveling track) of another moving body traveling in the opposite lane. FIG. 3 is a diagram for explaining a predicted traveling track for another moving body. In the example illustrated in FIG. 3, a vehicle 301 (that is, the vehicle 1) which is a self-vehicle is traveling in a traveling lane 302 on the movement route. In an opposite lane 304 of the traveling lane 302 illustrated in FIG. 3, the target 306 (for example, a vehicle) exists in a stationary state. In addition, the vehicle 305 travels in the opposite lane.

In a case where the vehicle 301 is traveling in the traveling lane 302, the target recognition unit 201 recognizes the state of the target including the positions, speeds, movement tracks, and the like of the vehicle 305 and the target 306. In addition, the traveling lane recognition unit 202 recognizes a traveling road boundary, a dividing line, and a lane region of the traveling lane 302 and the opposite lane 304.

In the example illustrated in FIG. 3, the stationary condition determination unit 203 determines whether or not a predetermined condition corresponding to that the target 306 existing in the opposite lane 304 is stationary is satisfied. For example, the stationary condition determination unit 203 can determine whether or not a predetermined condition is satisfied on the basis of the moving speed and the position of the target 306 existing in the opposite lane 304. Specifically, the stationary condition determination unit 203 determines that the predetermined condition is satisfied, for example, when the moving speed of the target 306 is equal to or less than a predetermined threshold, and the position of the target is away from the center of the opposite lane 304 by a predetermined distance or more in a direction away from the traveling lane 302 (that is, approaching the road boundary side). That is, a vehicle approaching the road boundary side and substantially stationary is a vehicle that is stopping or about to stop. In a case where there is the target 306 stopping in front of the traveling lane, the vehicle 305 travels on a traveling track for avoiding the target 306. On the other hand, a traveling target (vehicle) may temporarily stop due to a stop signal or the like. Since such a target (vehicle) stops substantially at the center on the lane, in normal cases, the vehicle 305 does not travel including steering for avoiding the target, but simply travels so as to decelerate.

The example illustrated in FIG. 3 illustrates a predicted traveling track 307 generated by the predicted track generation unit 204 in a case where the stationary condition determination unit 203 determines that the above-described predetermined condition is satisfied. The predicted traveling track 307 is a travelling track for avoiding the target 306 on which the vehicle 305 is predicted to travel. The predicted traveling track 307 includes an avoidance start point 308-1 and an avoidance end point 308-4 on a track in a case where the vehicle 305 travels straight. The avoidance start point 308-1 is also a start point of a first steering (for example, steering in the first direction). The vehicle 305 starts steering from the avoidance start point 308-1 and ends the first steering at a steering end point 308-2. The vehicle 305 travels straight to the next steering start point 308-3. Thereafter, steering is started at the steering start point 308-3 which is a start point of second steering (for example, steering in a second direction opposite to the first direction), and the second steering is ended at the avoidance end point 308-4. For example, a clothoid curve connects between the avoidance start point 308-1 and the steering end point 308-2 and between the steering start point 308-3 and the avoidance end point 308-4. The clothoid curve is a curve in which the curvature of the track changes linearly with respect to the distance. In general, the clothoid curve is also known as a track drawn by a vehicle when the vehicle equipped with a steering wheel rotates the steering wheel at a constant rate when the vehicle travels at a constant speed. By forming the traveling track using the clothoid curve, a complicated track having a high degree of freedom such as meandering to the left and right can be generated. Note that, in the present embodiment, an example is illustrated in which the predicted track generation unit 204 generates the predicted traveling track 307 by generating the track at one time, but a method of generating the track is not limited to this example. For example, the predicted track generation unit 204 may generate a traveling track for a case where the target 306 is not avoided, and then correct or change the traveling track such that the corrected or changed track becomes the predicted traveling track 307. In this case, the avoidance start point 308-1 and the steering end point 308-2 may be arranged on the traveling track when the target 306 is not avoided.

As described above, in a case where it is assumed that the vehicle 305 avoids the target 306 with high certainty, a predicted traveling track of the vehicle 305 for avoiding the target 306 is generated. This makes it possible to generate a highly reliable traveling track for the vehicle 305 traveling in another lane.

A travel control unit 205 generates a traveling track of the vehicle 301 with reference to the predicted traveling track generated for the vehicle 305. Then, the travel control unit 205 can control the traveling of the vehicle 301 on the basis of the determined traveling track. For example, in a case where the traveling track of the vehicle 301 is within a predetermined distance from the predicted traveling track 307, the travel control unit 205 can generate the traveling track so that the vehicle 301 moves away from the vehicle 305. Alternatively, the travel control unit 205 may generate the traveling track of the vehicle 301 so as to travel straight, and decelerate the vehicle 301 so that the traveling track of the vehicle 301 is away from the predicted traveling track 307 by a predetermined distance. That is, the travel control unit 205 controls at least one of the speed and steering of the vehicle 301 so that the vehicle 301 automatically travels according to the determined traveling track. In addition to the speed and the steering, the travel control unit 205 can perform various types of control necessary for automatic traveling on the determined traveling track. The automatic traveling may include automatic traveling of the vehicle that does not require the traveling operation by the driver, or automatic traveling for assisting the traveling operation by the driver.

For example, in a case where the predicted track generation unit 204 generates a predicted traveling track for the vehicle 305 to avoid the target 306, a notification unit 206 controls the input and output device 9 so as to notify the driver of the presence of the vehicle 305. In this case, the notification unit 206 notifies the driver of a predetermined warning sound or a voice using a natural language (including an expression representing the vehicle 305 or the target 306). For example, in case of notifying a voice, the notification unit 206 includes at least one of a position, a direction, and distance of the vehicle 305 or the target 306 and a time until collision with the vehicle 305. The notification unit 206 may display the contents to be notified on the display device 92. For example, the notification unit 206 causes the display device 92 to display information including at least one of a position, a direction, and distance of the vehicle 305 or the target 306, and a time until collision with the vehicle 305. The notification unit 206 may notify the driver in a case where the distance from the vehicle 301 to the vehicle 305 is equal to or less than a predetermined distance or the arrival time to the vehicle 305 is equal to or less than a predetermined time.

### <Series of Operations of Driving Assistance Processing in Vehicle>

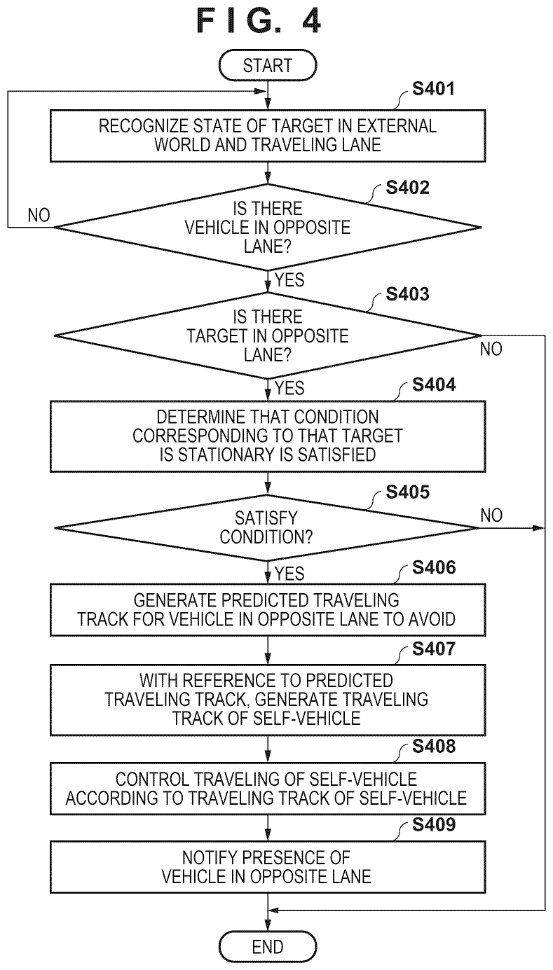

Next, with reference to FIG. 4, a series of operations of the driving assistance processing in a vehicle will be described. This processing is implemented, for example, by the processor 20a of the ECU 22 of the control device 2 executing a program in the memory 20b.

In S401, the target recognition unit 201 recognizes the state of the target in the external world of the vehicle 1 on the basis of the image obtained from the detection unit and the sensor information such as the LiDAR. In addition, the traveling lane recognition unit 202 recognizes the driving lane on which the vehicle 1 travels and the opposite lane on the basis of the image obtained from the detection unit and the sensor information such as the LiDAR.

In S402, the stationary condition determination unit 203 determines whether or not there is a vehicle in the opposite lane. For example, the stationary condition determination unit 203 determines whether or not there is a vehicle traveling in the position of the opposite lane using the recognition result of the target by the target recognition unit 201 and the recognition result by the traveling lane recognition unit 202. For example, the stationary condition determination unit 203 can determine the presence of a vehicle traveling in the opposite lane on the basis of the type of the target, the position of the target, the speed of the target, the movement track of the target, and the like. In a case where the stationary condition determination unit 203 determines that there is a vehicle traveling in the opposite lane, the processing proceeds to S403, and otherwise, the processing returns to S401.

In S403, the stationary condition determination unit 203 determines whether or not there is a target (different from the traveling vehicle) in the opposite lane. For example, the stationary condition determination unit 203 can determine the presence of a target different from the traveling vehicle on the basis of the type of the target, the position of the target, the speed of the target, the movement track of the target, and the like. The target may also include vehicles other than the vehicle determined in S402. In a case where the stationary condition determination unit 203 determines that there is the target in the opposite lane, the processing proceeds to S404, and otherwise, the processing ends (without performing subsequent processing).

In S404, the stationary condition determination unit 203 determines whether or not a predetermined condition corresponding to that a target existing in the opposite lane is stationary is satisfied. This processing will be described later as determination processing for a target. In S405, in a case where the stationary condition determination unit 203 determines that the predetermined condition is satisfied in S404, the processing proceeds to S406, and otherwise, the processing ends (without performing the subsequent processing). That is, in the present embodiment, in a case where the predetermined condition is not satisfied, the predicted track generation unit 204 does not generate the predicted traveling track (for the vehicle in the opposite lane to avoid the target). That is, in the present embodiment, in a case where it is not assumed that the vehicle in the opposite lane avoids the target with high certainty, the predicted traveling track for the vehicle to avoid the target is not generated. As described above, by limiting the case of generating the predicted traveling track of the vehicle in the opposite lane, the influence on the generation of the traveling track of the self-vehicle is limited, so that it is possible to stabilize the traveling track of the self-vehicle. In this case, for example, the predicted track generation unit 204 generates a predicted traveling track in which the vehicle in the opposite lane travels along the opposite lane (for example, along the center of the opposite lane). This makes it possible to reduce the influence of the predicted traveling track of the vehicle in the opposite lane on the traveling track of the self-vehicle and to stabilize the traveling track of the self-vehicle. In other words, it is possible to generate a highly reliable traveling track for another vehicle traveling in another lane.

In S406, the predicted track generation unit 204 generates a predicted traveling track for the vehicle in the opposite lane to avoid the target. The predicted track generation unit 204 generates the predicted traveling track 307 described above with reference to FIG. 3.

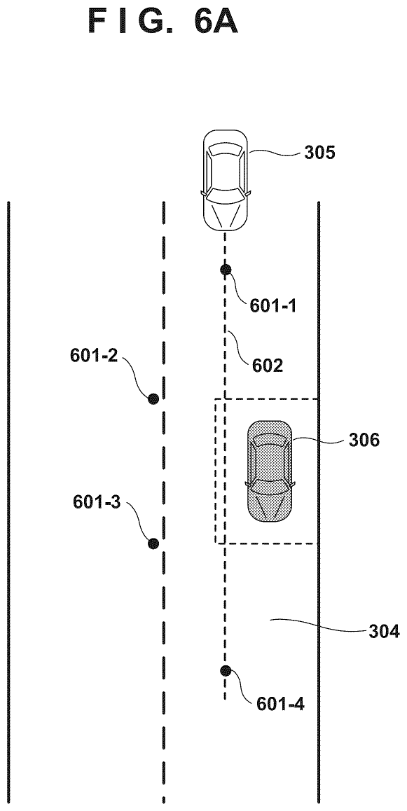

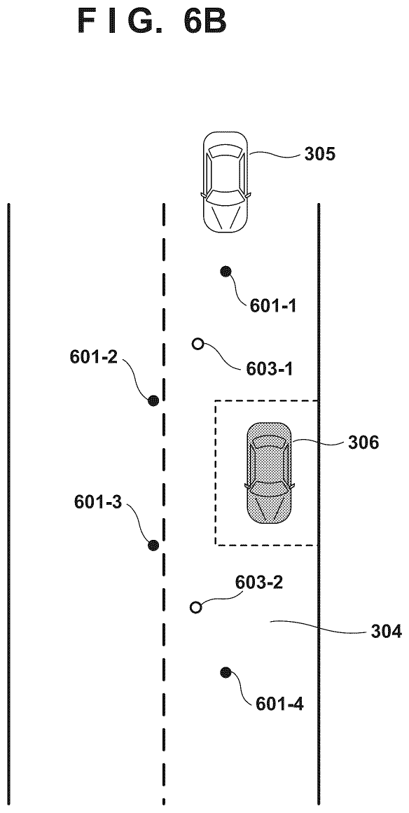

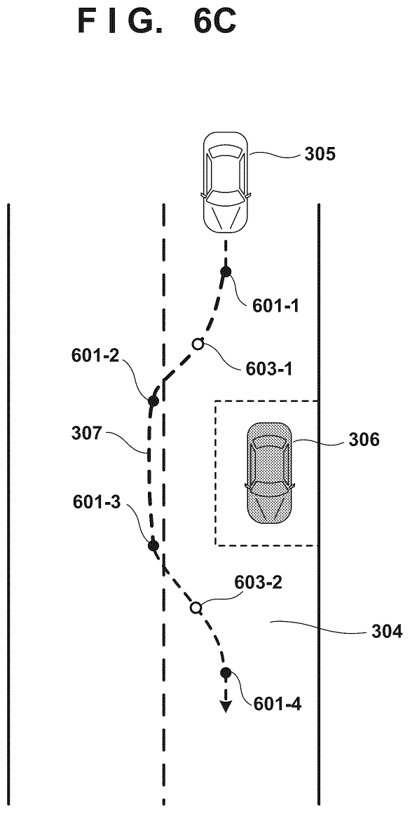

The processing of generating the predicted traveling track will be described with reference to FIGS. 6A to 6C. FIGS. 6A to 6C sequentially illustrate how the predicted track generation unit 204 generates the predicted traveling track. First, as illustrated in FIG. 6A, the predicted traveling track 307 arranges an avoidance start point 601-1 and an avoidance end point 601-4 on a track 602 in a case where the vehicle 305 travels straight. The interval between the avoidance start point 601-1 and the avoidance end point 601-4 may be set on the basis of the moving speed of the vehicle 305, for example.

The avoidance start point 601-1 is a start point of the first steering performed to avoid the target 306. This steering is, for example, steering in the direction of the lane in which the self-vehicle travels. The avoidance end point 601-4 indicates an end point of the traveling track for avoiding the target 306. After the avoidance end point 601-4, the vehicle 305 travels along the opposite lane (e.g., in the center of the opposite lane).

Furthermore, the predicted track generation unit 204 arranges a steering end point 601-2 and a steering start point 601-3 on a substantially straight line. The steering end point 601-2 indicates a position where the steering started from the avoidance start point 601-1 ends. For example, the predicted track generation unit 204 can determine the steering end point 601-2 as follows. The predicted track generation unit 204 specifies the size and the center point of the target 306 recognized in S402 and S403, and sets a rectangle (for example, a broken line frame in FIG. 3) corresponding to the size of the object on the basis of the specified center point. The predicted track generation unit 204 determines the steering end point 601-2 on the basis of the set rectangle and a predetermined margin distance for providing an interval between the set rectangle and the vehicle. The steering start point 601-3 indicates a position where the vehicle 305 starts the second steering for recovering to the traveling track along the opposite lane 304 after avoiding the target 306. The predicted track generation unit 204 can set the position of the steering start point 601-3 according to, for example, the size of the target recognized from the steering end point 601-2 or the size of the set rectangle.

Next, as illustrated in FIG. 6B, the predicted track generation unit 204 provides midpoints 603-1 and 603-2 between the avoidance start point 601-1 and the steering end point 601-2 and between the steering start point 601-3 and the avoidance end point 601-4, respectively. The midpoints 603-1 and 603-2 correspond to positions where the curvature of the clothoid curve peaks.

Finally, the predicted track generation unit 204 sets a clothoid curve passing through the avoidance start point 601-1, the steering end point 601-2, and the midpoint 603-1, and sets a clothoid curve passing through the steering start point 601-3, the avoidance end point 601-4, and the midpoint 603-2.

In S407, with reference to the predicted traveling track, the travel control unit 205 generates a traveling track of the self-vehicle (for example, the vehicle 301).

In S408, the travel control unit 205 generates a traveling track of the self-vehicle according to the traveling track of the self-vehicle. As described above, the travel control unit 205 controls at least one of the speed and steering of the self-vehicle so that the self-vehicle automatically travels according to the determined traveling track.

In S409, the notification unit 206 controls the input and output device 9 to notify the driver of the presence of the vehicle in the opposite lane (This is because the predicted track generation unit 204 has generated a predicted traveling track for the vehicle to avoid the target.).

### <Series of Operations of Determination Processing on Target>

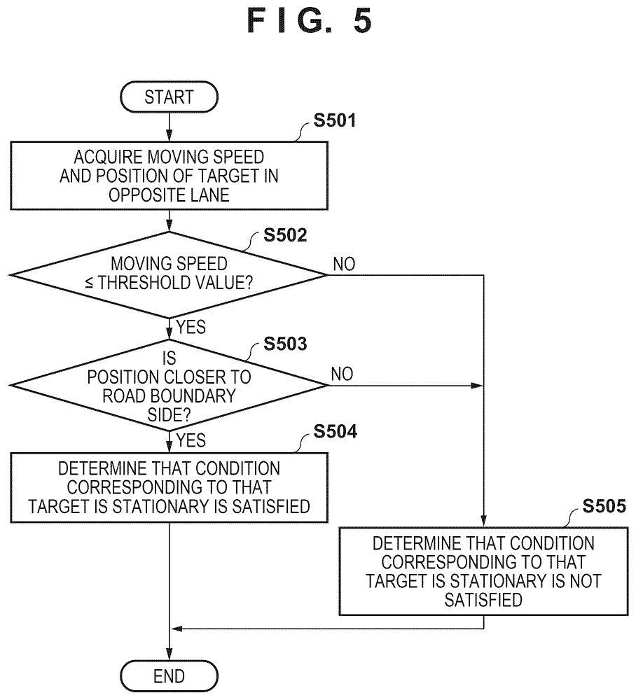

Next, a series of operations of determination processing on a target will be described with reference to FIG. 5. For example, the determination processing is implemented by the processor 20a of the ECU 22 of the control device 2 executing a program in the memory 20b. This processing is executed by the start of the processing of S404 described above.

In S501, the stationary condition determination unit 203 acquires the moving speed and the position of the target in the opposite lane. For example, the stationary condition determination unit 203 acquires, for example, information from the target recognition unit 201, and acquires the position of the target and the moving speed of the target.

In S502, the stationary condition determination unit 203 determines whether or not the moving speed of the target is equal to or less than a predetermined threshold. In a case where the stationary condition determination unit 203 determines that the moving speed of the target is equal to or less than the predetermined threshold, the processing proceeds to S503. Otherwise, the processing proceeds to S505.

In S503, the stationary condition determination unit 203 determines whether or not the position of the target is closer to the road boundary side than the center of the opposite lane. That is, the stationary condition determination unit 203 determines whether or not the position of the target is away from the center of the opposite lane by a predetermined distance or more in a direction away from the lane in which the self-vehicle travels. In a case where this determination is true, the stationary condition determination unit 203 advances the processing to S504, and otherwise, advances the processing to S505.

In S504, the stationary condition determination unit 203 determines that a condition corresponding to that the target is stationary is satisfied. On the other hand, in S505, the stationary condition determination unit 203 determines that the stationary condition determination unit 203 does not satisfy the condition corresponding to that the target is stationary. When completing the processing of S504 or S505, the stationary condition determination unit 203 returns the processing to a caller.

As described above, in the above-described embodiment, the state of the target in the external world of the vehicle is acquired, and the predicted traveling track of another vehicle (moving body) traveling in the opposite lane is generated. At this time, in a case where a predetermined condition corresponding to that a target existing in the opposite lane is stationary is satisfied, a predicted traveling track (for another vehicle to avoid the target) is generated. This makes it possible to predict a highly reliable traveling track for another moving body traveling in another lane (for example, in opposite lane).

In the example illustrated in FIG. 5, the stationary condition determination unit 203 determines whether or not a condition corresponding to that the target is stationary is satisfied on the basis of the moving speed of the target and the position of the target. However, the present invention is not limited to this example, and the stationary condition determination unit 203 may determine whether or not a condition corresponding to that the target is stationary is satisfied on the basis only of the moving speed of the target. In place of or in addition to the moving speed of the target, the stationary condition determination unit 203 may determine whether or not the relative speed between the vehicle 305 and the target 306 is equal to or higher than a predetermined value. When the relative speed is higher, the vehicle 305 may perform overtaking, and the vehicle 305 may travel on a traveling track for avoiding the target 306.

### SUMMARY OF EMBODIMENTS

### (Item 1)

A moving body control system comprising:
one or more processors; and
a memory storing instructions which, when the instructions are executed by the one or more processors, cause the moving body control system to function as:
a target recognition unit (for example, 201) configured to recognize a state of a target in an external world of a moving body (for example, 1); and
a generation unit (for example, 204) configured to generate a predicted traveling track of another moving body traveling in a specific lane different from a lane in which the moving body travels, wherein
the generation unit generates the predicted traveling track for the other moving body to avoid the target in a case where it is determined that a predetermined condition corresponding to that a target existing in the specific lane is stationary is satisfied (for example, S504) on a basis of a recognized state of a target.

According to the present invention, it is possible to generate a highly reliable traveling track for another moving body traveling in another lane.

### (Item 2)

The moving body control system according to item 1, wherein in a case where it is determined that the predetermined condition is not satisfied (for example, S505), the generation unit does not generate the predicted traveling track for the other moving body to avoid a target existing in the specific lane.

According to this embodiment, by limiting the case of generating the predicted traveling track of a moving body in a specific lane, the influence on the generation of the traveling track of the own moving body is limited, so that it is possible to stabilize the traveling track of the own moving body.

### (Item 3)

The moving body control system according to item 2, wherein in a case where it is determined that the predetermined condition is not satisfied, the generation unit generates the predicted traveling track in which the other moving body travels along the specific lane.

According to this embodiment, it is possible to reduce the influence of the predicted traveling track of the moving body in a specific lane on the traveling track of the own moving body.

### (Item 4)

The moving body control system according to item 1, wherein the instructions further cause the moving body control system to function as
a determination unit (for example, 203) configured to determine whether or not the predetermined condition is satisfied on a basis of a recognized state of a target, wherein
the determination unit determines that the predetermined condition is satisfied in a case where moving speed of the target existing in the specific lane is equal to or less than a predetermined threshold.

According to this embodiment, in a case where it is assumed that another moving body avoids the target with high certainty, it is possible to generate the predicted traveling track.

### (Item 5)

The moving body control system according to item 1, wherein the instructions further cause the moving body control system to function as
a determination unit (for example, 203) configured to determine whether or not the predetermined condition is satisfied on a basis of a recognized state of a target, wherein
the determination unit determines whether or not the predetermined condition is satisfied on a basis of moving speed and a position of the target existing in the specific lane.

According to this embodiment, it is possible to accurately specify a target which is highly likely to be avoided by another moving body.

### (Item 6)

The moving body control system according to item 5, wherein the determination unit determines that the predetermined condition is satisfied in a case where moving speed of the target existing in the specific lane is equal to or less than a predetermined threshold and a position of the target is away from a center of the specific lane by a predetermined distance or more in a direction away from a lane in which the moving body travels.

According to this embodiment, it is possible to distinguish between a temporary stop of a target traveling in a specific lane and a parked target, and it is possible to accurately specify a target which is highly likely to be avoided by a moving body.

### (Item 7)

The moving body control system according to item 1, wherein the generation unit generates the predicted traveling track for the other moving body to avoid the target existing in the specific lane by connecting four passing points including a start point and an end point of the predicted traveling track with a clothoid curve.

According to this embodiment, it is possible to accurately predict the traveling track of another moving body in a specific lane.

### (Item 8)

The moving body control system according to item 1, wherein the instructions further cause the moving body control system to function as a control unit (for example, 205) configured to control traveling of the moving body with reference to a predicted traveling track generated for the other moving body.

According to this embodiment, it is possible to control own traveling in consideration of a predicted traveling track of another moving body in a specific lane.

### (Item 9)

The moving body control system according to item 8, wherein traveling of the moving body includes automatic traveling of the moving body not requiring a traveling operation by a driver or automatic traveling for assisting the traveling operation by the driver.

According to this embodiment, it is possible to provide automatic traveling or driving assistance in consideration of a predicted traveling track of another moving body.

### (Item 10)

The moving body control system according to item 9, wherein the control unit controls at least one of speed and steering of the moving body so as to follow a traveling track of the moving body in a case of performing automatic traveling of the moving body not requiring a traveling operation by a driver.

According to this embodiment, it is possible to provide automatic traveling in consideration of a predicted traveling track of another moving body.

### (Item 11)

The moving body control system according to item 8, wherein the control unit controls a notification unit to notify a driver of the moving body of the presence of the other moving body configured to avoid a target existing in the specific lane.

According to this embodiment, it is possible to notify the driver of another moving body that can approach while avoiding a target in a specific lane to call attention.

### (Item 12)

A moving body (for example, 1) comprising:
one or more processors; and
a memory storing instructions which, when the instructions are executed by the one or more processors, cause the moving body to function as:
a target recognition unit (for example, 201) configured to recognize a state of a target in an external world of a moving body;
a generation unit (for example, 204) configured to generate a predicted traveling track of another moving body traveling in a specific lane different from a lane in which the moving body travels; and
a control unit (for example, 205) configured to control traveling of the moving body with reference to a predicted traveling track generated for the other moving body, wherein
in a case where it is determined that a predetermined condition corresponding to that a target existing in the specific lane is stationary is satisfied on a basis of a recognized state of a target, the generation unit generates the predicted traveling track for the other moving body to avoid the target.

According to the present invention, it is possible to generate a highly reliable traveling track for another moving body traveling in another lane.

### (Item 13)

A control method of a moving body control system, comprising:
recognizing (for example, S401) a state of a target in an external world of a moving body; and
generating (for example, S406) a predicted traveling track of another moving body traveling in a specific lane different from a lane in which the moving body travels, wherein
generating the predicted traveling track for the other moving body includes generating the predicted traveling track for the other moving body to avoid the target in a case where it is determined that a predetermined condition corresponding to that a target existing in the specific lane is stationary is satisfied on a basis of a recognized state of a target.

According to the present invention, it is possible to generate a highly reliable traveling track for another moving body traveling in another lane.

### (Item 14)

A non-transitory computer-readable storage medium storing a program for causing a computer to function as each unit of a moving body control system, wherein the moving body control system comprising:
a target recognition unit (for example, 201) configured to recognize a state of a target in an external world of a moving body; and
a generation unit (for example, 204) configured to generate a predicted traveling track of another moving body traveling in a specific lane different from a lane in which the moving body travels, and
in a case where it is determined that a predetermined condition corresponding to that a target existing in the specific lane is stationary is satisfied on a basis of a recognized state of a target, the generation unit generates the predicted traveling track for the other moving body to avoid the target.

According to the present invention, it is possible to generate a highly reliable traveling track for another moving body traveling in another lane.

The invention is not limited to the foregoing embodiments, and various variations/changes are possible within the spirit of the invention.

What is claimed is:

1. A moving body control system comprising:
one or more processors; and
a memory storing instructions which, when the instructions are executed by the one or more processors, cause the moving body control system to function as:
a target recognition unit configured to recognize a state of a target in an external world of a moving body; and
a generation unit configured to generate a predicted traveling track of another moving body traveling in a specific lane different from a lane in which the moving body travels, wherein
the generation unit generates the predicted traveling track for the other moving body to avoid the target in a case where it is determined that a predetermined condition corresponding to that a target existing in the specific lane is stationary is satisfied on a basis of a recognized state of a target.

2. The moving body control system according to claim 1, wherein in a case where it is determined that the predetermined condition is not satisfied, the generation unit does not generate the predicted traveling track for the other moving body to avoid a target existing in the specific lane.

3. The moving body control system according to claim 2, wherein in a case where it is determined that the predetermined condition is not satisfied, the generation unit generates the predicted traveling track in which the other moving body travels along the specific lane.

4. The moving body control system according to claim 1, wherein the instructions further cause the moving body control system to function as
a determination unit configured to determine whether or not the predetermined condition is satisfied on a basis of a recognized state of a target, wherein
the determination unit determines that the predetermined condition is satisfied in a case where moving speed of the target existing in the specific lane is equal to or less than a predetermined threshold.

5. The moving body control system according to claim 1, wherein the instructions further cause the moving body control system to function as
a determination unit configured to determine whether or not the predetermined condition is satisfied on a basis of a recognized state of a target, wherein
the determination unit determines whether or not the predetermined condition is satisfied on a basis of moving speed and a position of the target existing in the specific lane.

6. The moving body control system according to claim 5, wherein the determination unit determines that the predetermined condition is satisfied in a case where moving speed of the target existing in the specific lane is equal to or less than a predetermined threshold and a position of the target is away from a center of the specific lane by a predetermined distance or more in a direction away from a lane in which the moving body travels.

7. The moving body control system according to claim 1, wherein the generation unit generates the predicted traveling track for the other moving body to avoid the target existing in the specific lane by connecting four passing points including a start point and an end point of the predicted traveling track with a clothoid curve.

8. The moving body control system according to claim 1, wherein the instructions further cause the moving body control system to function as a control unit configured to control traveling of the moving body with reference to a predicted traveling track generated for the other moving body.

9. The moving body control system according to claim 8, wherein traveling of the moving body includes automatic traveling of the moving body not requiring a traveling operation by a driver or automatic traveling for assisting the traveling operation by the driver.

10. The moving body control system according to claim 9, wherein the control unit controls at least one of speed and steering of the moving body so as to follow a traveling track of the moving body in a case of performing automatic traveling of the moving body not requiring a traveling operation by a driver.

11. The moving body control system according to claim 8, wherein the control unit controls a notification unit to notify a driver of the moving body of the presence of the other moving body configured to avoid a target existing in the specific lane.

12. A control method of a moving body control system, comprising:
recognizing a state of a target in an external world of a moving body; and
generating a predicted traveling track of another moving body traveling in a specific lane different from a lane in which the moving body travels, wherein
generating the predicted traveling track for the other moving body includes generating the predicted traveling track for the other moving body to avoid the target in a case where it is determined that a predetermined condition corresponding to that a target existing in the specific lane is stationary is satisfied on a basis of a recognized state of a target.

13. A non-transitory computer-readable storage medium storing a program for causing a computer to function as each unit of a moving body control system, wherein the moving body control system comprising:
a target recognition unit configured to recognize a state of a target in an external world of a moving body; and
a generation unit configured to generate a predicted traveling track of another moving body traveling in a specific lane different from a lane in which the moving body travels, and
in a case where it is determined that a predetermined condition corresponding to that a target existing in the specific lane is stationary is satisfied on a basis of a recognized state of a target, the generation unit generates the predicted traveling track for the other moving body to avoid the target.
